(19) United States
(12) Patent Application Publication
(10) Pub. No.: US 2009/0117319 A1
(43) Pub. Date: May 7, 2009

(54) FOUNDATION PROTECTOR SYSTEM

(76) Inventor: Theodore G. HUBERT, Surrey (CA)

Correspondence Address: CAMERON IP, SUITE 1401 - 1166 ALBERNI STREET, VANCOUVER, BC, V6E 3Z3, CA

(21) Appl. No.: 12/350,718

(22) Filed: Jan. 8, 2009

Related U.S. Application Data
(63) Continuation of application No. 10/858,077, filed on Jun. 2, 2004, now abandoned.

(30) Foreign Application Priority Data
Jun. 3, 2003 (CA) 2,430,721

(51) Int. Cl. B32B 3/30

(52) U.S. Cl. 428/77

(57) ABSTRACT

A foundation protection system for the exterior surface of a foundation wall has a membrane of plastic material on the exterior surface of the foundation wall, the membrane having a marginal edge portion, and a support strip extending along the entire marginal edge portion of the membrane. The membrane and the securement member have interengaged projecting and recessed portions, with fasteners penetrating through the support strip and the membrane into the foundation wall and thereby securing the support strip and the membrane to the foundation wall. The support strip may have a flexible flange in sealing contact with the foundation wall upwardly beyond the marginal edge portion of the membrane along the entire length of the marginal edge portion of the membrane. A slot-shaped recess extends along the support strip for temporarily holding nails or screws during installation.

### RELATED APPLICATION

This is a continuation application of U.S. patent application Ser. No. 10/858,077 filed on Jun. 2, 2004.

### BACKGROUND OF THE INVENTION

1. Field of the Invention

The present invention relates to surface coverings and is useful, more particularly, for foundation protection systems and for securement strips for use in such systems.

2. Description of the Related Art

For protecting a foundation wall against the effects of moisture, it is known to install against the exterior surface of the foundation wall a foundation protector sheet or membrane which is made of waterproof material and which is dimpled, so that the dimples of such sheet or membrane can be placed against the exterior surface of the foundation wall to allow moisture to seep downwardly through spaces between the dimples, between the protector sheet or membrane and the exterior surface of the foundation wall.

The dimples of the foundation protector sheet or membrane, which project from one side of the foundation protector sheet or membrane, form corresponding recesses in the opposite side of the foundation protector sheet or membrane.

During the installation of the foundation protector system, and after the foundation protector sheet or membrane has been installed on the foundation wall exterior surface, the foundation is backfilled and, consequently, soil is pressed against the outer surface of the protector sheet or membrane and into the recesses. When this occurs, and during subsequent subsidence of the ground around the foundation wall, this soil tends to drag the foundation protector sheet or membrane downwardly and away from the foundation exterior surface.

To counteract such displacement of the foundation protector sheet or membrane from its correct position on the foundation wall exterior surface, fasteners of various types have been previously employed. For example, in U.S. Pat. No. 6,523,309, issued Feb. 25, 2003 to Shane Finley, there is disclosed a fastening plate for securing a membrane to a substrate, the fastening plate being shaped to interengage recesses in the outer surface of a foundation protector membrane and to be secured to the substrate by a nail driven through the fastening plate and through the foundation protector or membrane into the substrate.

In use, a plurality of such fastening plates is required to be spaced apart along the foundation protector membrane.

However, it has been found, in practice, that the use of such fastening plates is unsatisfactory because the foundation protector membrane is dragged downwardly, in the above-described manner, and sags between the fastening plates. These prior fastening plates, therefore, do not effectively seal the entire edge of the foundation protector membrane and it is consequently necessary, in practice, to caulk the edge of the foundation protector membrane.

Therefore, the use of such spaced apart fastening plates requires some means other than the fastening plates themselves to close and seal the gaps between the surface of the substrate or foundation wall and the foundation protector membrane along the top of the foundation protector membrane.

### BRIEF SUMMARY OF THE INVENTION

According to the present invention, there is provided a securement strip for securing a marginal edge portion of a foundation protector sheet to a foundation wall, the foundation protector sheet having projections on one side thereof for abutment against the foundation wall and recesses on opposite sides thereof, with spaces between the projections, the securement strip comprising a first portion extending along the securement strip and formed with protrusions for engagement in the recesses in the foundation protector sheet, and a second portion extending along the first portion, the second portion comprising a flexible flange extending at an angle from the first portion for flexed engagement with the foundation wall above the foundation protector sheet so as to close the spaces between the projections of the foundation protector sheet, the first portion being adapted to receive fasteners for fastening the securement strip and, therewith, the foundation protector sheet to the foundation wall.

When the securement strip according to the present invention is in use, the length of the securement strip is selected so that it is long enough to extend, by itself or together with one or more similar securement strips, along the entire length of the foundation protector sheet so as to ensure that the foundation protector sheet is supported along the entirety of the foundation protector sheet to prevent moisture and soil from entering between the top of the foundation protector sheet and the foundation wall.

In a preferred embodiment of the invention, a sealing strip, e.g. of foam material, is provided along the length of the flexible flange for sealing the latter to the foundation wall.

Also, a slot-shaped recess is formed along the securement strip for receiving and gripping the tips of nails or screws. This greatly facilitates the installation of the securement strip, since one or more nail or screw tips can be inserted into this recess before the securement strip is interengaged with the foundation protector sheet, thereby enabling the person carrying out the installation to employ both hands for gripping and positioning the securement strip and, if necessary, for simultaneously gripping and adjusting the upper edge of the foundation protector sheet. Also, the slot-shaped recess enables nails or screws to be employed at any position along the marginal edge portion of the waterproof sheet, and therefore avoids problems which would otherwise arise when, for example, a waterproof sheet of metric dimensions is attached to a building foundation of imperial dimensions, which may occur for example when the foundation protector is applied to wood or IF foundations.

The insertion of nails at any position along with the length of the securement strip is also particularly advantageous when the securement strip is installed around a corner of the foundation wall.

Also according to the present invention, there is provided surface covering on a substrate, comprising a membrane of plastic material, the membrane having a marginal edge portion, a securement member extending along the marginal edge portion of the membrane, the membrane and the support strip, in this case a securement member, having interengaged projecting and recessed portions, the support strip having a flexible marginal portion extending upwardly into sealing contact with the substrate beyond the marginal edge portion of the membrane along the entire length of the marginal edge portion of the membrane, and fasteners extending through the support strip and the membrane into the substrate and thereby securing the support strip and the membrane to the substrate.

The invention will be more readily understood from the following description of preferred embodiments thereof given, by way of example only, with reference to the accompanying drawings, in which:—

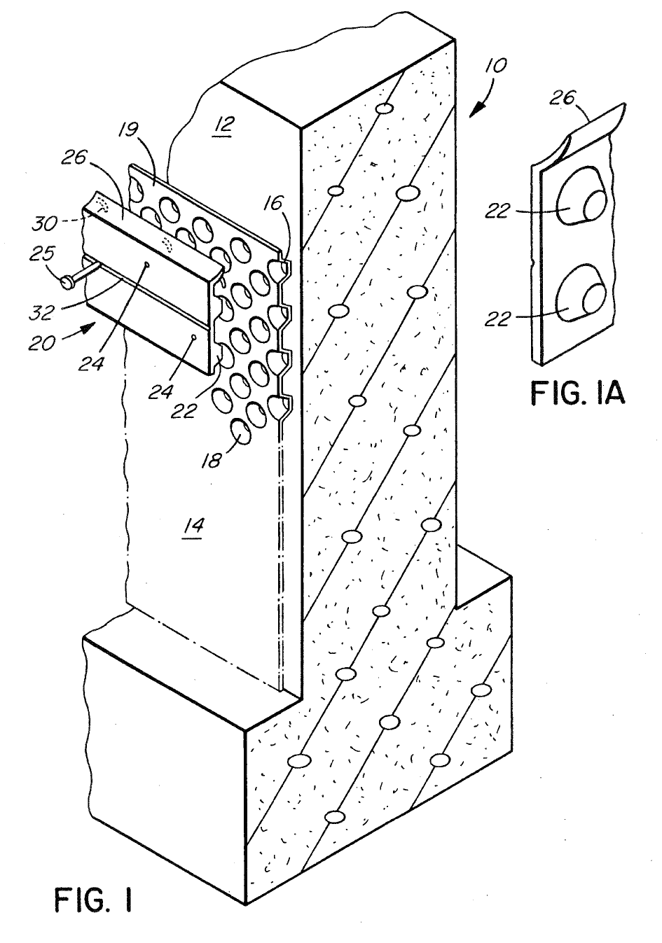

FIG. 1 shows a broken-away view, in perspective, of a part of a foundation wall provided with a foundation protector system embodying the present invention;

FIG. 1A shows a broken-away portion in perspective of a part of a securement strip forming a component of the system of FIG. 1;

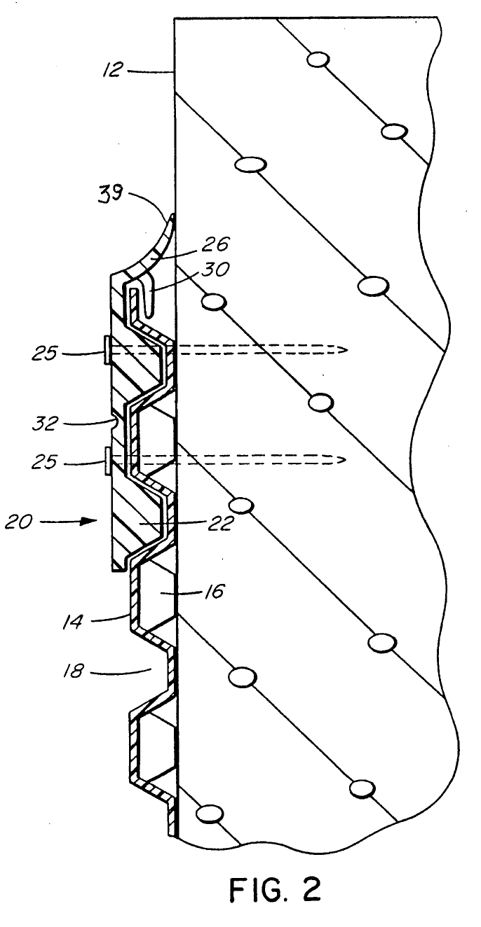

FIG. 2 shows a view in front elevation of the foundation wall and the foundation protector system of FIG. 1;

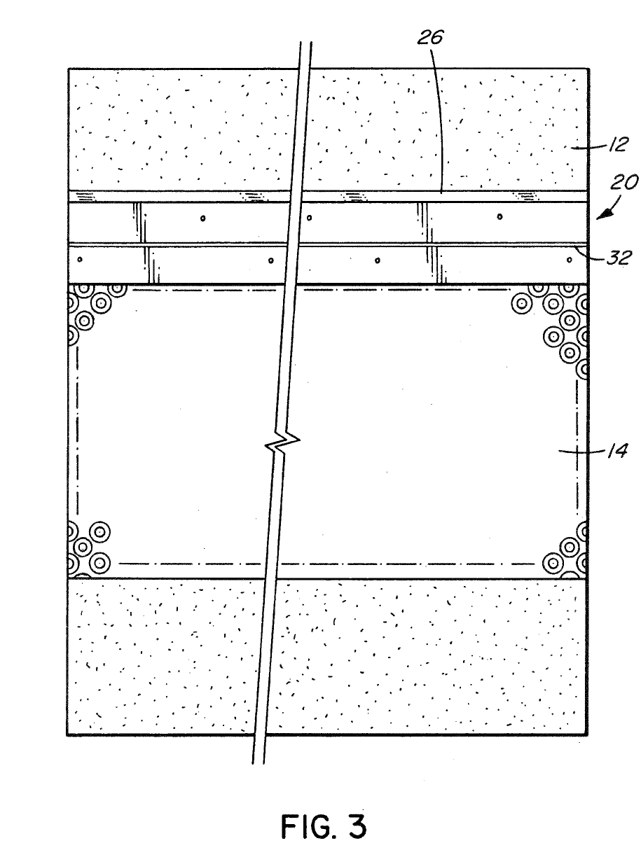

FIG. 3 shows a view taken in vertical cross-section through the foundation wall and foundation protector system of FIG. 1;

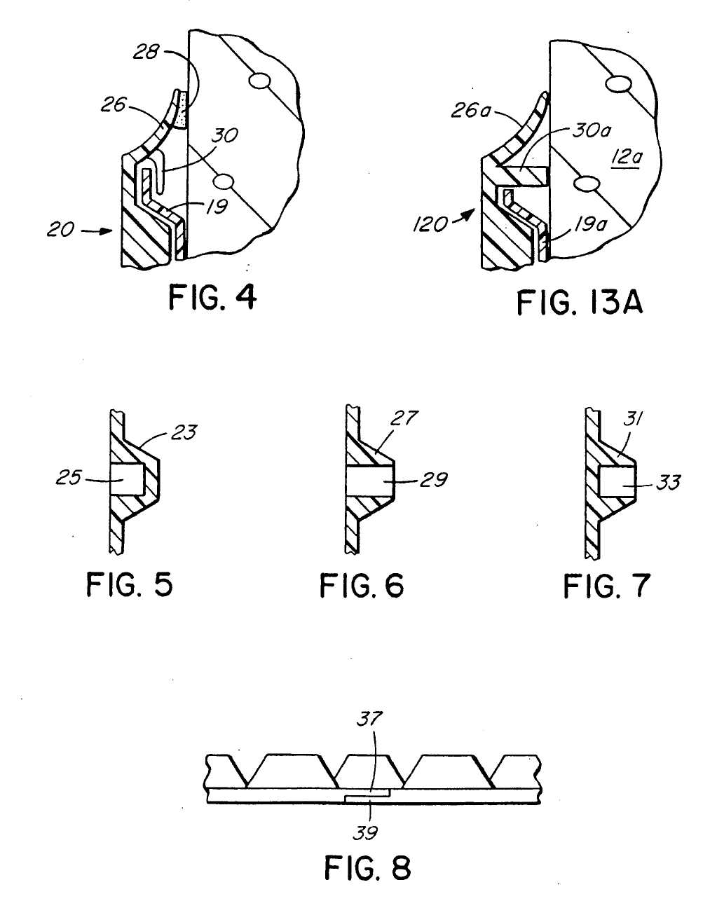

FIG. 4 shows a broken-away view, in vertical cross-section, through parts of a foundation wall and a modification of the foundation protector system of FIG. 1;

FIGS. 5, 6 and 7 show broken-away views, in vertical cross-section, through parts of modified foundation protector sheets;

FIG. 8 shows a broken-away plan view of overlapping ends of a pair of securement strips;

FIGS. 9, 10 and 11 show broken-away views in perspective of interengageable portions of foundation protector sheets and securement strips;

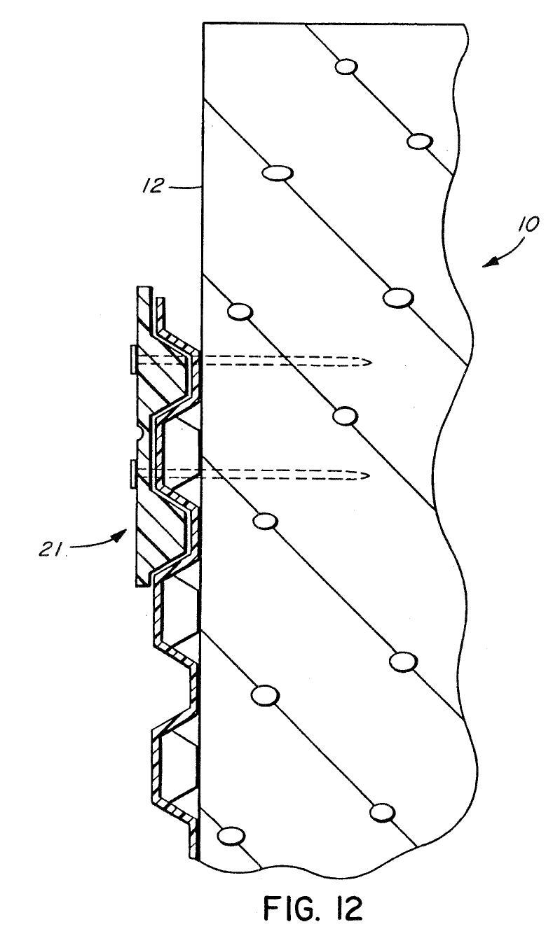

FIG. 12 shows a modified securement strip according to another embodiment of the present invention;

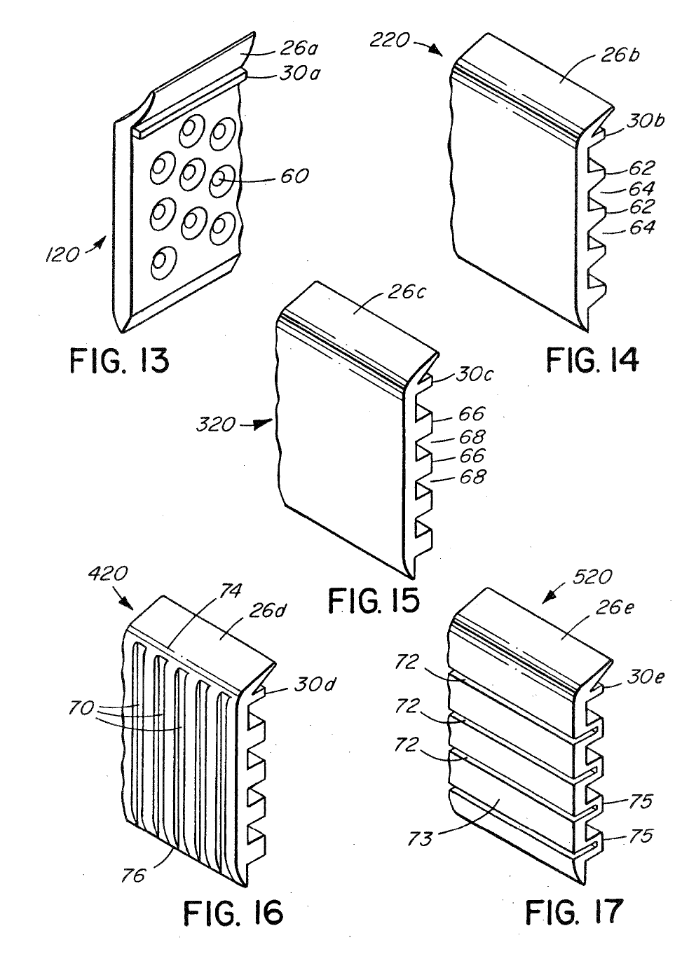

FIGS. 13, 14, and 15 show broken-away views in perspective of securement strips with various forms of protrusions and recesses in the first portion of the securement strip, according to other embodiments of the invention;

FIG. 13A shows a broken-away view, in vertical cross-section, through parts of a foundation wall and a foundation protector system employing the securement strip of FIG. 13;

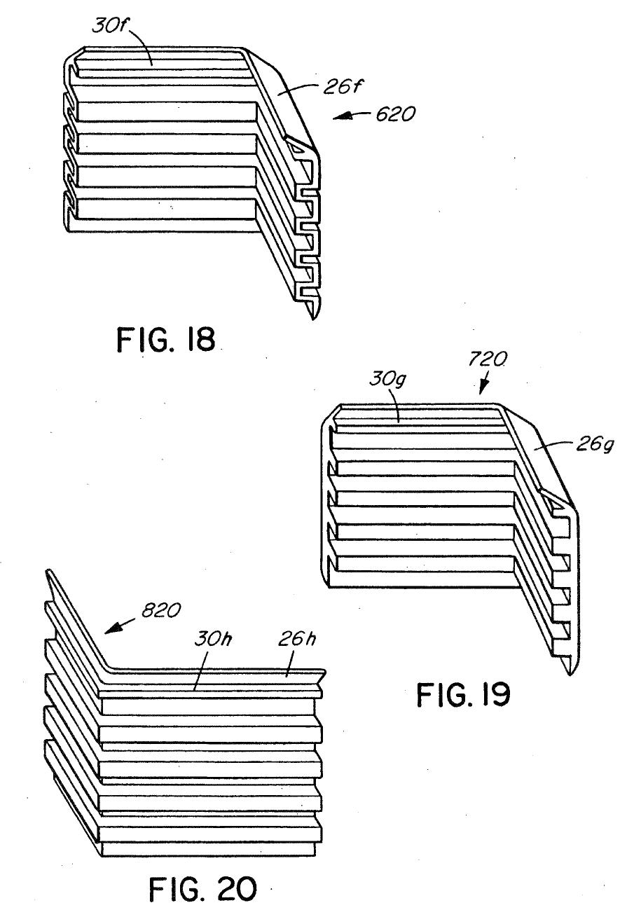

FIGS. 17 and 18 show broken-away views in perspective of securement strips with protrusions and recesses in an opposing side of the securement strip according to other embodiments of the invention;

FIGS. 18, 19, and 20 show perspective views of angled securement strips according to other embodiments of the invention;

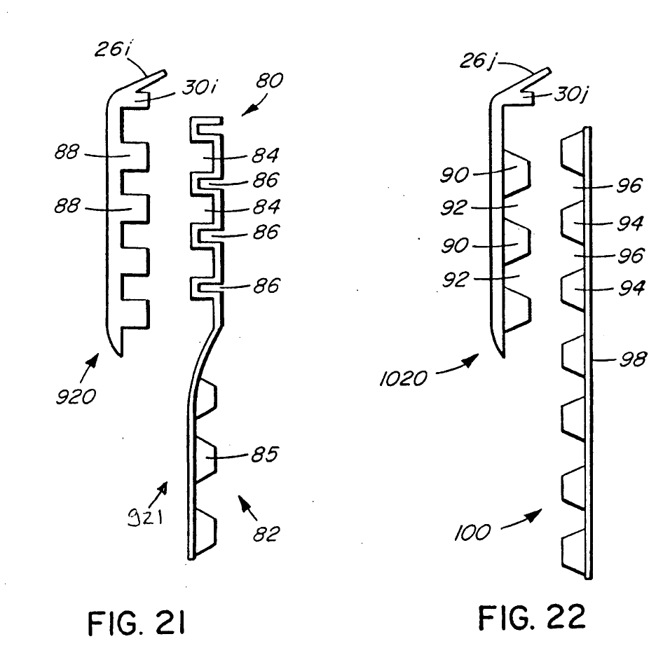

FIGS. 21 and 22 show broken-away views taken in side elevation of two forms of securement strips and foundation protector sheets.

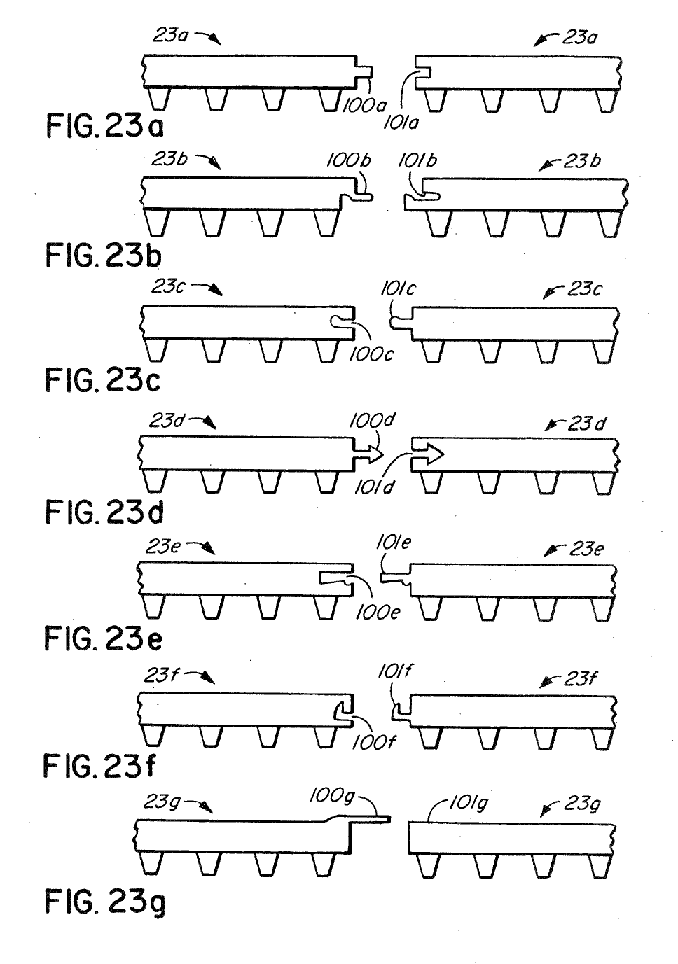

FIGS. 23a-g show plan views of securement strips having interconnecting formations.

### DESCRIPTION OF THE PREFERRED EMBODIMENT

Referring firstly to FIG. 1 of the accompanying drawings, there is shown a foundation wall indicated generally by reference 10 having an exterior surface 12. A foundation protector sheet or membrane 14 is located on the exterior surface 12 of the foundation wall 10.

The foundation protector sheet 14 is a dimpled sheet formed at one side thereof with a plurality of protrusions 16, in the form of dimples of frusto-conical cross-sectional shape, which project toward and abut the exterior surface 12 of the foundation wall 10. Each of these protrusions 16 forms, at the opposite side of the foundation protector sheet 14, a corresponding frusto-conically shaped recess 18.

Along the entire length of a marginal edge portion 19 of the foundation protector sheet 14, which may e.g. be a horizontal marginal edge portion or a vertical marginal edge portion of the foundation protection sheet 14, there is provided at least one securement strip, indicated generally by reference numeral 20. The securement strip 20 is extruded from high density polyethylene, but may alternatively be made from low density polyethylene or partly propylene and any other suitable plastic material, and may be of any desired color. The securement strip 20 is formed, at an inner side thereof, with a plurality of protrusions 22 (FIG. 1A). These protrusions 22 have a frusto-conical cross-sectional shape complementary to that of the recesses 18, and the protrusions 22 are spaced from one another in an array corresponding to that of the recesses 18 in such a manner that the protrusions 22 on the securement strip 20 can engage in respective ones of the recesses 18 along a marginal edge portion 19 of the foundation protector sheet 14.

The securement strip 20 is formed with nail holes 24, which are distributed along the length of the securement strip 20. Nails 25 (FIG. 2) can be driven through these nail holes 24 and through the foundation protector sheet 14 into the foundation wall 10 to fasten the securement strip 20, and therewith the marginal edge portion 19 of the foundation protector sheet 14, into position on the exterior surface 12 of the foundation wall 10. It used to be understood that, in some cases, the nails 25 may be replaced by screws (not shown).

The securement strip 20 includes, along its entire upper edge, a flexible flange 26 which is angled from the securement strip 20 toward the exterior surface 12 of the foundation wall 10. More particularly, as can be seen from FIG. 2, the flexible flange 26 has an outer edge 39 which is pressed against the exterior surface 12 of the foundation wall 10 when the securement strip 20 is secured to the foundation wall 10 by the nails 25. The flexible flange 26 serves to seal the securement strip 20 to the exterior surface 12 of the foundation wall 10 and, thereby, to provide a seal, above the upper edge of the foundation protector sheet 14, to the exterior surface 12 so as to prevent moisture and contaminants from passing downwardly between the foundation protector sheet 14 and the exterior surface 12 through the gaps or spacings between the protrusions 16 of the foundation protector sheet 14.

The sealing of the flange 26 against the surface 12 may be enhanced, as illustrated in FIG. 4, by the provision of a sealing strip 28 provided on the flexible flange 26 and extending along the entire length of the flexible flange 26. This sealing strip 28, which is preferably made of foam material, is compressed between the flexible flange 26 and the foundation wall exterior surface 12.

As shown in FIGS. 1, 2 and 4, the securement strip 20 is provided with a plurality of prongs 30, which are spaced apart along the flexible flange 26, at the side of the securement strip 20 facing the foundation wall 10. These prongs 30 extended downwardly from the flexible flange 26 and, during installation of the foundation protector system, can be hooked over the marginal edge portion 19 of the foundation protector step 14 so as to temporarily hold the protector strip 20 in position relative to the top of the foundation protector sheet 14 while the securement strip 20 and the foundation protector sheet 14 are manipulated into position on the foundation wall exterior surface 12.

The side of the securement strip 20 which faces away from the exterior surface 12 of the foundation wall 10 is formed, along the entire length of the securement strip 20, with a longitudinally extending, slot-shaped recess 32. This recess 32 is dimensioned to receive and grip the tips of nails, and thereby to temporarily retain the nails in position relative to the securement strip 20, during the installation of the foundation protector system. When the foundation protector sheet 14 and to the securement strip 20 have been properly positioned on the exterior surface 12 of the foundation wall 10, these nails can then be hammered through the securement strip 20 and the foundation protector sheet 14 into the foundation wall 10. The recess 32 thereby facilitates the installation of the foundation protector system by a person who can use both of his hands to grip and position the securement strip 28 and the top of the foundation protector sheet 14 without requiring that person to use one of his hands to hold the nails in position relative to the securement strip 20.

As shown in FIG. 2, the protrusions 22 are solid. However, these solid protrusions may be replaced by hollow protrusions as shown in FIGS. 5, 6 and 7. The protrusion shown in FIG. 5, and indicated generally by reference numeral 23 is a hollow protrusion having a cylindrical hollow interior 25 which opens at the side of the securement strip opposite from the protrusions 23, while FIG. 6 shows a protrusion 27 having a cylindrical opening 29 open at opposite sides of the securement strip. In FIG. 7, there is shown a protrusion 31 having a hollow interior space 33 which is open toward the foundation wall 10.

The securement strip 20 may, in practice, be one of a plurality of securement strips extending along the marginal edge portion of one or more foundation protector sheets. In that case, the securement strips may have overlapping end portions 35 and 37, as shown in FIG. 8.

Since the purpose of the protrusions on the securement strip is to support the foundation protector sheet against downward displacement, the lower halves of the protrusions 22 may be omitted, as shown, for example, in FIG. 9, in which protrusions modified in this manner are indicated by reference numerals 40, which are semi-cylindrical and which are shaped and dimensioned to interengage with cylindrical recesses 42 in the foundation protector sheet.

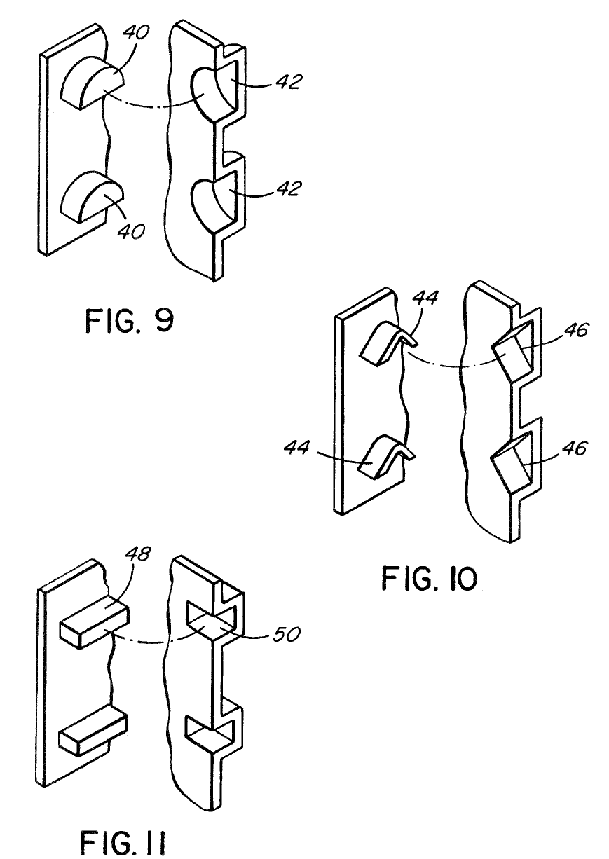

FIG. 10 shows chevron-shaped protrusions 44 on the securement strip for engagement in upper portions of rectangular recesses 46 in the foundation protector sheet.

FIG. 11 shows horizontally rectangular or bar-shaped protrusions 48 for engagement in corresponding recesses 50.

FIG. 12 shows a modified securement strip, which is indicated generally by reference numeral 21, and which is similar to the securement strip 20 of FIGS. 1 to 4, except that in the case of the securement strip 21 the flexible flange 26 has been omitted. The securement strip 21 therefore, does not provide a seal between the marginal edge portion 19 and the foundation wall surface. For that purpose, caulking or some other sealing means may be employed. However, the securement strip 21, by itself or in combination with one or more other securement strips (not shown) extends continuously along the marginal edge portion 19 and, therefore, supports and secures the marginal edge portion 19 relative to the foundation exterior surface 12 along the entirety of the marginal edge portion 19.

FIGS. 13 through 15 show different forms of the protrusions and recesses of the inner side of the securement strip according to other embodiments of the invention.

More particularly, FIG. 13 shows frusto-conical recesses 60 in a securement strip 120 which engage complementary protrusions (not shown) on a foundation protector sheet 19a (FIG. 13A) on a foundation 12a.

FIG. 14 shows a securement strip 220 with elongate protrusions 62 and recesses 64 in the form of ribs having trapezoidal cross-sections. The protrusions 62 and recesses 64 inter-engage complementary protrusions and recesses (not shown) of a corresponding foundation protector sheet (not shown).

FIG. 15 shows a securement strip 320 with protrusions 66 and recesses 68 in the form of ribs having square cross-sections. Again, these protrusions 66 and recesses 68 interengage complementary protrusions and recesses (not shown) in a corresponding foundation protector sheet (not shown).

FIG. 16 shows a securement strip 420 having slot-shaped recesses 70 that extend from the flange 74 to a bottom edge 76 of the strip 420. These slot-shaped recesses 70 make the securement strip 20 more flexible to facilitate coiling of the securement strip 420 for storage and transport or cutting to size.

FIG. 17 shows a securement strip 20 having slot-shaped recesses 72 in one side of the strip 520 and protrusions 75 on the opposite side of the strip 520, the protrusions extending around the slots 72.

FIGS. 18 through 20 show angled securement strips 20 for use as corner pieces for securing foundation protector sheets around corners of foundation walls (not shown).

More particularly, in FIG. 18 reference numeral 620 indicates generally a securement strip forming a corner piece for use with the strip 520 of FIG. 17, and in FIG. 19 reference numeral 720 indicates generally a securement strip forming a corner piece for use with the securement strip 420 of FIG. 16, both for use at projecting corners of foundation walls. In FIG. 20, reference numeral 820 indicates generally a securement strip 820 in the form of a corner piece for use in corner recesses of foundation walls.

FIGS. 21 and 22 show other embodiments of the securement strip for securing other forms of foundation protector sheets to foundation walls.

More particularly, in FIG. 21 reference numeral 921 indicates generally a foundation protector sheet having upper and lower portions indicated generally by reference numerals 80 and 82, respectively. The upper portion 80 has recesses 84 and 86 on opposite sides. The securement strip 920 has protrusions 88 complementary in shape to and interengageable with the recesses 84. The lower portion 82 has frusto-conically shaped protrusions, on one side thereof, for abutment against the foundation wall.

FIG. 22 shows a securement strip 1020 with frusto-conically shaped protrusions 90 and recesses 92 that inter-engage a foundation protector sheet 100 with complementary frusto-conically shaped protrusions 94 and corresponding recesses 96. In this embodiment the foundation protector sheet has a flat surface 98 that abuts a foundation wall.

The securement strips 120, 220, 320, 420, 520, 620, 720, 820, 920 and 1020 are each formed with an elongate projection in the form of a rib indicated by reference numerals 30a-30j, respectively, which extends horizontally along the side of the securement strip which, in use, faces the foundation wall. These ribs 30a-30j are of rectangular cross-section and in use are located immediately below flexible flanges 26a-26j, which correspond to the flexible flange 26 of FIGS. 1-4 and serve the same purpose, and above the interengaged protrusions and recesses of the securement strip and the foundation protector sheet.

In use, the ribs 30a-30j abut the foundation wall above the foundation protector sheet and serve as a stop to limit the extent to which the flexible flanges 26a-26j are deformed by the back fill.

Thus, as shown for example in FIG. 13A, which shows a broken-away view of the securement strip 120 supporting a foundation protector sheet 14a which corresponds to the sheet 14 of FIGS. 1-4, on a foundation wall 12a, the projection 30a extends above the foundation protector sheet 14a to the wall 12a and limits deformation of the securement strip, including the flexible flange 26a.

An elongate projection such as the ribs 30a-30j may be provided in place of the prongs 30 of FIGS. 1-4 and vice versa.

Still further embodiments of the securement strip of the invention indicated generally by reference numerals 23a-23g in FIGS. 23a-g, which each show a like pair of the strips.

FIGS. 23a-f show like pairs of securement strips formed with end connector formations 100a-f, which are interengageable with end formations 101a-f of the respective like ones of the strips for connecting the pairs of strips together end-to-end.

FIG. 23g shows a longitudinally projecting end portion 102 atone end of strip 23g for overlapping a like securement strip to connect the two strips 23g end-to-end.

As will be readily apparent to those skilled in the art, various modifications may be made in the above described embodiments of the present invention within the scope of the appended claims. For example, the protrusions may have various shapes other than those shown in the accompanying drawings and described above.

1-19. (canceled)

20. A surface covering for a substrate, comprising:—
a) a membrane of plastic material;
b) the membrane having an upper marginal edge portion;
c) a support strip for extending along the upper marginal edge portion of the membrane;
d) the membrane and the support strip being formed with mutually interengageable protrusions and recesses, the support strip supporting the membrane by interengagement of the protrusions and recesses to inhibit downward displacement of the membrane; and
e) the support strip having a flexible upper marginal portion extending upwardly for sealing contact with the substrate beyond the upper marginal edge portion of the membrane along the entire length of the upper marginal edge portion of the membrane.

21. A surface covering as claimed in claim 20, including a projection extending from the support strip as a stop for limiting deformation of the support strip, the projection being located below the flexible upper marginal portion and above the interengageable protrusions and recesses.

22. A surface covering as claimed in claim 20, the membrane having an upper portion, the recesses comprising horizontal slots in the upper portion, and a lower portion with projections on one side thereof for abutment against the substrate, the protrusions comprising longitudinally extending ribs on the securement strip engaging in the slots.

23. A surface covering as claimed in claim 22, wherein the slots and ribs are of complementary square cross-sectional shapes.

24. A surface covering as claimed in claim 22, wherein the slots and ribs are of complementary tapered cross-sectional shapes.

25. A surface covering as claimed in claim 22, wherein the securement strip is formed with vertical slots in a side thereof opposite from the ribs.

26-27. (canceled)

28. A surface covering as claimed in claim 20, wherein the protrusions and recesses are substantially frusto-conically shaped.

29. A surface covering as claimed in claim 20, wherein opposite ends of the support strip have end connector formations interengageable with corresponding formations of like securement strips for connecting the strips end-to-end.

30. A surface covering as claimed in claim 20, wherein one end of the securement strip is formed with a longitudinally projecting portion for overlapping an adjacent like securement strip.

31. A surface covering as claimed in claim 20, further including fasteners extending through the support strip and the membrane into the substrate and thereby securing the support strip and the membrane to the substrate.
